(19) United States
(12) Patent Application Publication
(10) Pub. No.: US 2026/0155379 A1
(43) Pub. Date: Jun. 4, 2026

(54) BINDER FOR SECONDARY BATTERY ELECTRODE INCLUDING FUNCTIONALIZED CELLULOSE, AND SECONDARY BATTERY INCLUDING THE SAME

(71) Applicant: UIF (University Industry Foundation), Yonsei University, Seoul (KR)

(72) Inventors: Sang Young LEE, Seoul (KR); Nag Young Kim, Seoul (KR); Yoo Jin Kim, Seoul (KR)

(73) Assignee: UIF (University Industry Foundation), Yonsei University, Seoul (KR)

(21) Appl. No.: 19/405,984

(22) Filed: Dec. 2, 2025

(30) Foreign Application Priority Data
Dec. 3, 2024 (KR) 10-2024-0177342
Jul. 11, 2025 (KR) 10-2025-0093858

(51) Int. Cl. H01M 4/62; C09J 101/28

(52) U.S. Cl. CPC H01M 4/622; C09J 101/288

(57) ABSTRACT

The present invention relates to a binder for a secondary battery electrode including functionalized cellulose, and a secondary battery including the same, and specifically relates to a high-performance secondary battery having high energy density per weight and volume and excellent rate capability and cycle life characteristics, by using a functionalized cellulose-based polymer binder to improve adhesion to the current collector, alleviate non-uniformity such as concentration gradient of inert materials caused by the drying process, and detachment and cracking of the electrode layer, and improve mechanical properties, and by reducing high ion conductivity resistance and charge transfer resistance occurring in conventional high-density electrodes, thereby overcoming the limitations of high-loading and high-density electrode implementation.

### CROSS-REFERENCE TO RELATED APPLICATIONS

This application claims priority to Korean Patent Application Nos. 10-2024-0177342 and 10-2025-0093858, filed on Dec. 3, 2024 and Jul. 11, 2025, respectively and all the benefits accruing therefrom under 35 U.S.C. § 119, the contents of which in their entirety are herein incorporated by reference.

### BACKGROUND

### 1. Field

The present invention relates to a binder for a secondary battery electrode including functionalized cellulose, and a secondary battery including the same.

### 2. Description of the Related Art

Lithium-ion secondary batteries are widely used in various fields such as portable consumer electronics, large electric vehicles, and energy storage devices. To expand the scope of battery application, energy density and price competitiveness are considered the most important factors. Initially, development focused on high-voltage and high-capacity active materials, but as physical limitations were reached, thick electrode technology began to gain attention as an alternative. The thick electrode can not only increase energy density through a thick electrode layer but also reduce manufacturing costs by reducing the number of components.

However, conventional wet electrode manufacturing processes have a fundamental problem called material separation phenomenon. When a slurry mixed with an active material, a conductive agent, and a binder is dried, the conductive agent and the binder migrate to the surface due to capillary forces. This causes inert materials that hinder ion movement to accumulate on the upper part of the electrode, and lack of adhesion on the lower part results in detachment or cracking of the electrode layer. This phenomenon is particularly severe in thick electrodes, which hinders the realization of high-performance electrodes.

In high-density electrodes using conventional binders, the binder completely covers the surface of the active material, leading to simultaneous increases in ion transport resistance and charge transfer resistance. This significantly reduces charging and discharging efficiency. This is because the molecular bonding mechanism between the binder and the active material has not been sufficiently studied.

To solve these problems, various new material binders, such as conductive polymers and cross-linked polymers, have been developed. Although some performance improvement effects were observed, non-uniform material distribution and reduced adhesion persisted because the interaction between constituent materials was not optimized under high-capacity and high-density conditions.

Recently, organic nanofiber binders have garnered attention as a new solution. The fine fiber structure forms a 3D network, improving the path for ion migration, and the strong intermolecular forces due to the high surface area ensure structural stability. In particular, the flexible nature of nanofibers effectively prevents cracking even during electrode deformation. However, the problem remains that uniform distribution within the electrode is difficult to achieve due to the phenomenon of aggregation between nanofibers.

### REFERENCES

1. Korean Laid-Open Patent Publication No. 2013-0116528
2. Korean Registered Patent Publication No. 10-1198295
3. Adv. Funct. Mater. 2019. 29, 1902772

### SUMMARY

The object of the present invention is to solve the problems mentioned above, by using a functionalized cellulose-based polymer binder to improve adhesion to the current collector, alleviate non-uniformity such as concentration gradient of inert materials caused by the drying process, and detachment and cracking of the electrode layer, and improve mechanical properties, and by reducing high ion conductivity resistance and charge transfer resistance occurring in conventional high-density electrodes, thereby overcoming the limitations of high-loading and high-density electrode implementation, and consequently providing a high-performance secondary battery having high energy density per weight and volume and excellent rate capability and cycle life characteristics.

One aspect of the present invention relates to a binder for a secondary battery electrode including functionalized cellulose, wherein the functionalized cellulose is selected from one or more modified celluloses such that a cationic functional group is bonded thereto or modified celluloses such that a polar functional group is bonded thereto.

Another aspect of the present invention relates to a composition for a secondary battery wet cathode, including the binder for a secondary battery electrode according to various embodiments of the present invention.

Another aspect of the present invention relates to a secondary battery wet cathode including the binder for a secondary battery electrode according to various embodiments of the present invention.

Another aspect of the present invention relates to a secondary battery including the wet cathode according to various embodiments of the present invention.

Another aspect of the present invention relates to a device selected from one of portable electronic devices, mobile units, power devices, and energy storage systems, including the secondary battery according to various embodiments of the present invention.

The electrode binder composition for a secondary battery of the present invention, through a polymer binder based on cationic cellulose nanofibers, not only possesses excellent dispersibility and high adhesion, including low interfacial resistance compared to conventional binders, even without conventional fluorine-based binders such as PVDF, but also contributes to the formation of a stable electrode-electrolyte interface by reducing ion transport resistance within the electrode and charge transfer resistance at the active material-electrolyte interface. Consequently, it is possible to enable the fabrication of high-capacity thick electrodes and high-density electrodes that could not be achieved with PVDF binders, thereby realizing high energy density per weight and volume, and providing a high-performance secondary battery having excellent rate capability and cycle life characteristics.

### BRIEF DESCRIPTION OF THE DRAWINGS

FIGS. 1A to 1C show the structures of PVdF, CNF, and cationic CNF, respectively.

FIG. 2 shows the results of FT-IR analysis for comparing the internal interaction of CNF and the internal interaction of cationic CNF (c-CNF).

FIG. 3 is a TEM image for each of CNF and cationic CNF.

FIG. 4 shows the results of adhesion energy (work of adhesion) analysis and Raman analysis through contact angle measurement for each of the conventional PVdF binder and cationic CNF.

FIG. 5 is a graph comparing the slurry elasticity and viscosity of PVdF and c-CNF.

FIG. 6 is a graph comparing the interfacial resistance of PVdF and c-CNF.

FIG. 7 is a graph comparing the ion conductivity resistance values within the electrodes of PVdF and c-CNF.

FIG. 8 is a graph comparing the rate capability and cycle life performance of each battery manufactured using PVdF and c-CNF as binders.

FIGS. 9A and 9B are graphs showing that high-loading and high-density cathodes can be realized based on cationic CNF.

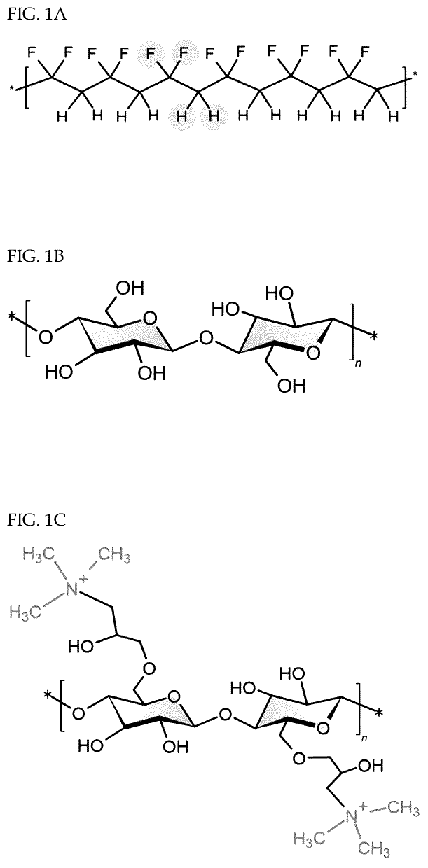

### DETAILED DESCRIPTION

Hereinafter, examples of the present invention will be described in detail with reference to the accompanying drawings so that those skilled in the art to which the present invention belongs can easily carry it out.

However, the following description is not intended to limit the present invention to specific embodiments, and concrete descriptions of related known techniques are omitted when it is determined that they may obscure the subject matter of the present invention.

The terminology used herein is merely for the purpose of describing particular examples and is not intended to limit the present invention. A singular expression includes a plural expression unless the context clearly indicates otherwise. In the present application, terms such as “comprise” or “have” are intended to specify the presence of features, numbers, steps, operations, components, or combinations thereof described in the specification, and are not understood to exclude the possibility of the presence or addition of one or more other features, numbers, steps, operations, components, or combinations thereof.

One aspect of the present invention relates to a binder for a secondary battery electrode including functionalized cellulose.

The functionalized cellulose is selected from one or more modified celluloses such that a cationic functional group is bonded thereto or modified celluloses such that a polar functional group is bonded thereto.

The functionalized cellulose binder for a secondary battery electrode according to the present invention, compared to conventional binders such as PVdF, shows increased viscosity and elasticity, which improves rheological stability during electrode coating, and can exhibit high flatness even in thick electrodes, for example, those with a thickness of 200 μm or more.

According to one embodiment, the binder according to various embodiments of the present invention is for a wet cathode of a secondary battery.

In the present invention, a wet cathode refers to a cathode manufactured by a wet method, and specific contents will be described later.

The functionalized cellulose binder for a secondary battery electrode according to the present invention, even when compared to non-functionalized cellulose (e.g., CNF) binders, has the advantage of significantly reduced fiber-to-fiber aggregation, enabling the formation of a uniform 3D network structure; specifically, it enables homogeneous mixing of the active material or conductive agent within the slurry during the wet manufacturing process of the electrode, and can greatly reduce the component separation phenomenon caused by capillary forces generated during the drying process.

Furthermore, unlike other cases, especially when used as a binder in the manufacturing process of a wet cathode, the adhesion between the cathode active material and the cathode current collector can be greatly improved, and the affinity with the conductive agent can also be improved, which not only greatly improves dispersibility, but also has the advantage of showing reduced interfacial resistance between the electrode-current collector and improved electron migration efficiency.

According to another embodiment, the cationic functional group may be selected from one or more functional groups of the ammonium (—NH₄⁺), primary to quaternary ammonium (—NH₃R⁺, —NH₂R₂⁺, —NHR₃⁺, —NR₄⁺), pyridinium (-Py+), imidazolium (-Im⁺), triazolium (-Trz⁺), thiazolium (-Thz⁺), phosphonium (e.g., —PR₄⁺), sulfonium (e.g., —SR₃⁺), hydrazonium (—N₂H₅⁺), or peroxyammonium (—N(O₂) R₃⁺) series.

In addition, the polar functional group may be selected from one or more of a carboxyl group (—COOH), a cyano group (—C═N), an amino group (—NH₂), a secondary or tertiary amine group (—NHR, —NR₂), a thiol group (—SH), —O—(C═O) OH, O—C—NH₂, an ether group (—O—), an ester group (—C(O)O—), an amide group (—C(O) NH—), a carbonate group (—OC(O)O—), a urea group (—NHC(O) NH), a urethane group (—OC(O) NH—) and an imide group (—C(O) NH—C(O)—).

According to yet another embodiment, the functionalized cellulose is represented by the following Chemical Formula 1.

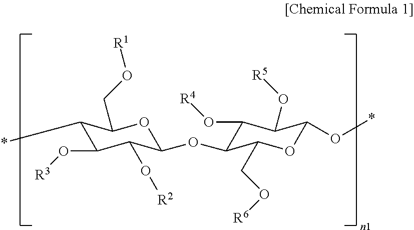

In Chemical Formula 1, n1 is an integer from 100 to 10,000,
R₁ to R₆ are each independently selected from a hydrogen atom,

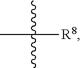

and

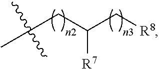

at least some of R₁ to R₆ are each independently

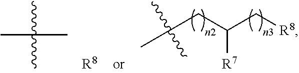

n2 and n3 are each independently an integer from 1 to 4,
R⁷ is selected from a hydrogen atom, a hydroxyl group, and a C₁-C₄ alkyl group,

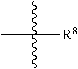

is selected from

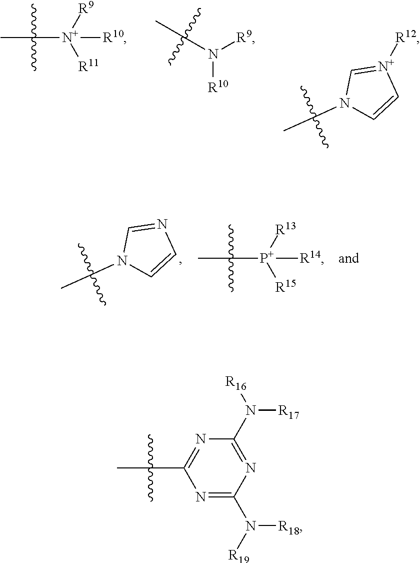

and
R⁹ to R¹⁹ are each independently a hydrogen atom or a C₁-C₄ alkyl group.

When the wet cathode binder specifically has the structure of Chemical Formula 1 above, the cationic CNF can suppress the layer-by-layer separation phenomenon of components within the electrode by forming a 3D network through electrostatic interaction with the negatively charged active material and conductive agent, and the fibrous structure and cationic functional groups generate Li ion migration pathways, which allows for low polarization resistance even under high-rate discharge conditions, and the adhesion force at the current collector-electrode interface is significantly improved, which can lead to the effect of greatly reducing the electrode area peeling rate (for example, the electrode peeling area is less than 3% after 1,000 charge/discharge cycles).

According to yet another embodiment, the functionalized cellulose is represented by the following Chemical Formula 2.

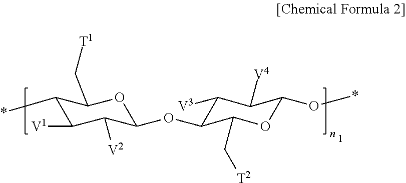

In Chemical Formula 2, n1 is an integer from 100 to 10,000,

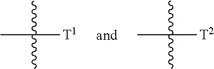

are each independently selected from a hydroxyl group,

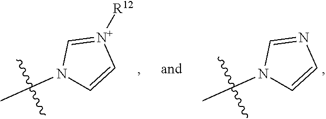

n4 is an integer from 1 to 5,
R¹² is a hydrogen atom or a C₁-C₄ alkyl group, and
V¹ to V⁴ are each independently a hydroxyl group or a C₁-C₄ alkoxy group.

According to yet another embodiment, the binder for a secondary battery electrode, wherein the functionalized cellulose is represented by the following Chemical Formula 3.

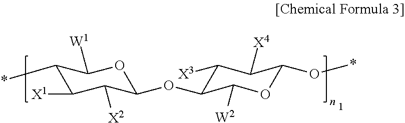

In Chemical Formula 3, n1 is an integer from 100 to 10,000,

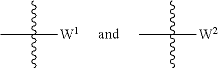

are each independently selected from a hydroxymethyl group,

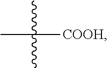 [SMILES: *C(=O)O]

and

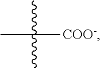

and
X¹ to X⁴ are each independently a hydroxyl group or a C₁-C₄ alkoxy group.

According to yet another embodiment, the functionalized cellulose is represented by the following Chemical Formula 4.

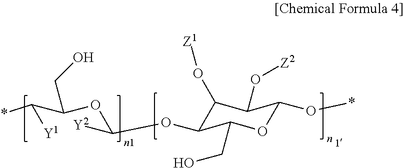

In Chemical Formula 4, n1 and n1′ are each independently an integer from 100 to 10,000,

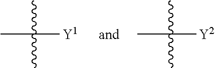

are each independently selected from

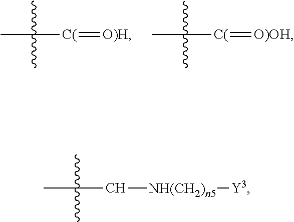

and

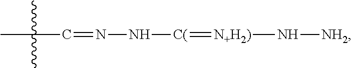

or

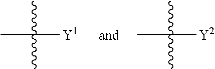

are connected to each other to form

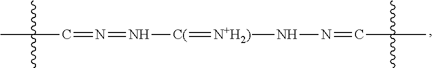

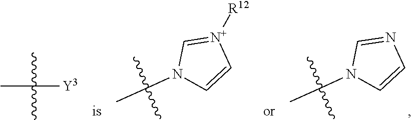

and
R¹² is a hydrogen atom or a C₁-C₄ alkyl group.

According to yet another embodiment, the functionalized cellulose is selected from one or more functionalized celluloses having the following structures.

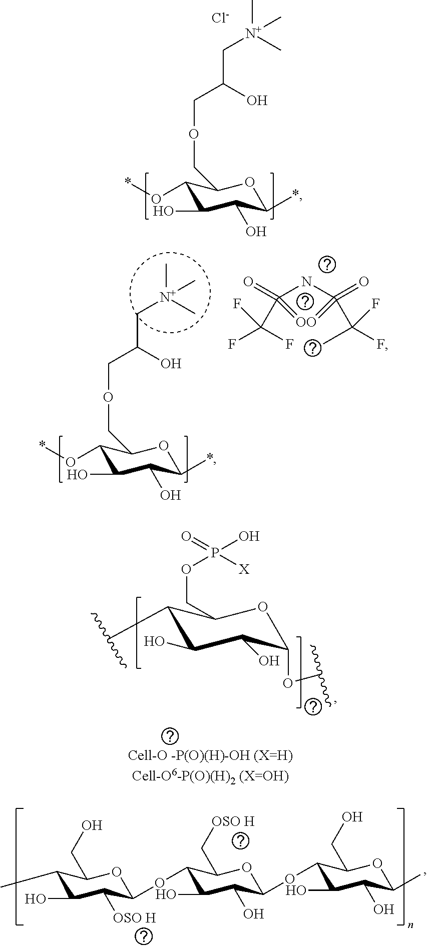

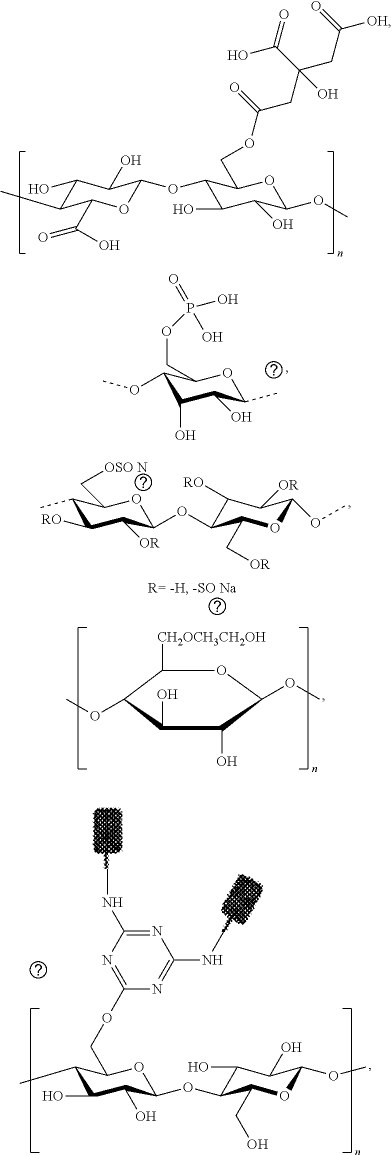

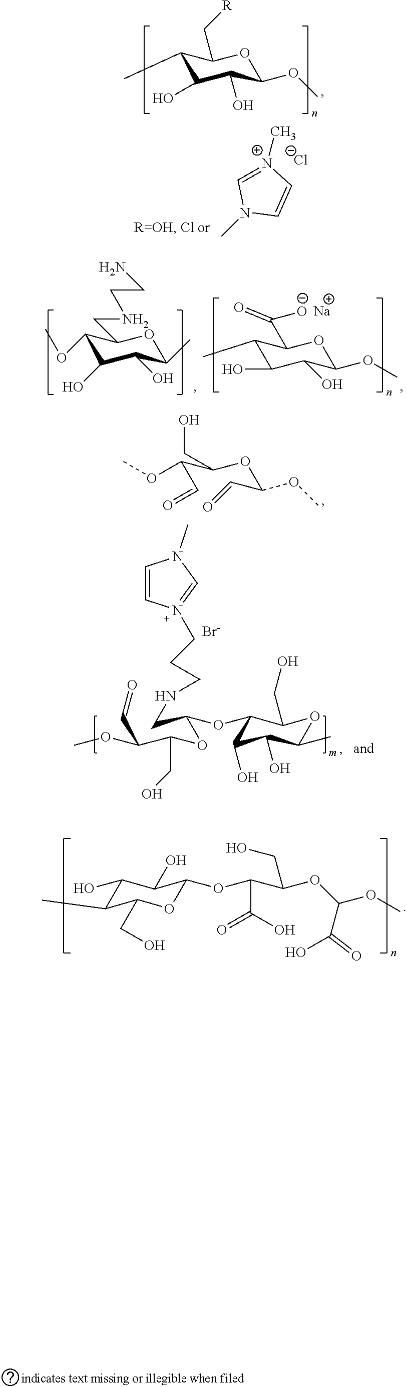

The functionalized cellulose of the present invention may be modified such that functional groups are introduced into the cellulose by conventionally known methods, and it is obvious that based on the disclosure of the present invention, those skilled in the art can easily manufacture, purchase, or secure the functionalized cellulose of the present invention based on current technical common sense.

However, the manufacturing methods for some of the functionalized celluloses of the present invention are exemplarily presented below, but are not limited to the following methods or structures.

First, the Type 1 functionalized cellulose represented by Chemical Formula 1 above is a cellulose modified by introducing functional groups to all or part of the hydroxyl groups (—OH) present in the cellulose, and includes, for example, a functionalized cellulose that can be manufactured by the following methods, but is not limited to the following methods or structures.

(1) Ammonium Series Functional Groups (e.g., —N⁺H₃, —N⁺H₂R—N⁺HR₂, —N⁺R₃, —CH₂CH(OH)CH₂N⁺R₃)

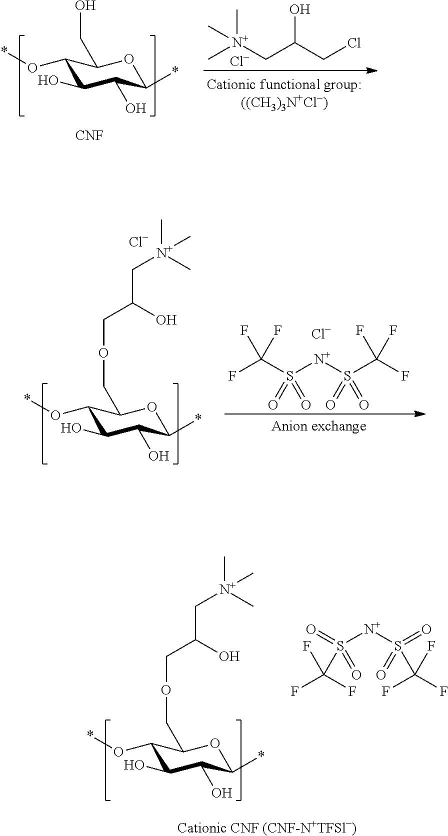

(2) Phosphonium or Phosphorate Series Functional Groups (e.g., —P⁺H₃, —P⁺H₂R, —P⁺HR₂, —P⁺R₃, —P(═O)HOH, —P(═O)(OH)₂)

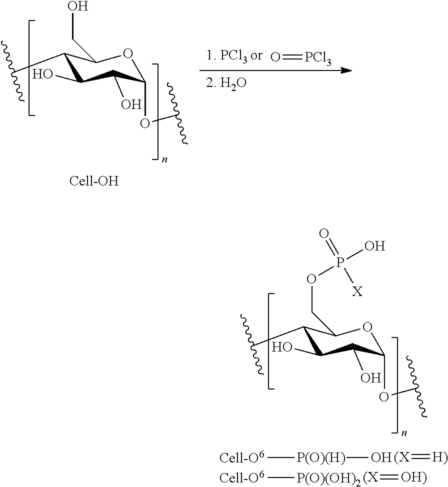

(3) Sulfonium or Sulfonate Series Functional Groups (e.g., —S⁺H₂), —S⁺HR, —S⁺R₂, —S(═O)₂OH, —S(═O)OH, —S(═O)₂H)

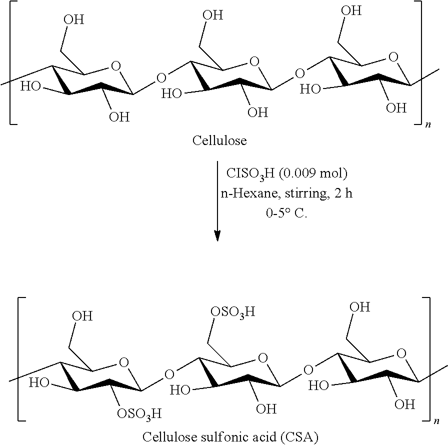

### (4) Carboxyl Group Series Functional Groups

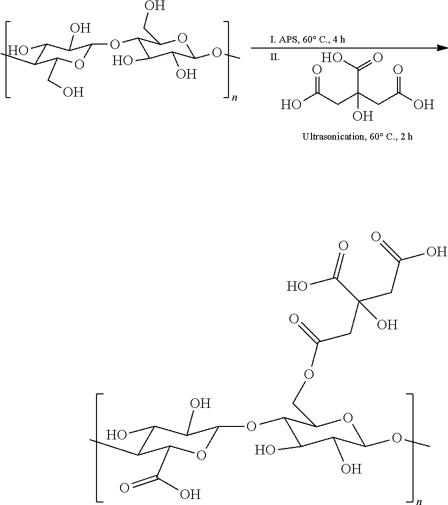

(5) Phosphate Series Functional Groups (e.g., —P⁺(═O)(OH)₂)

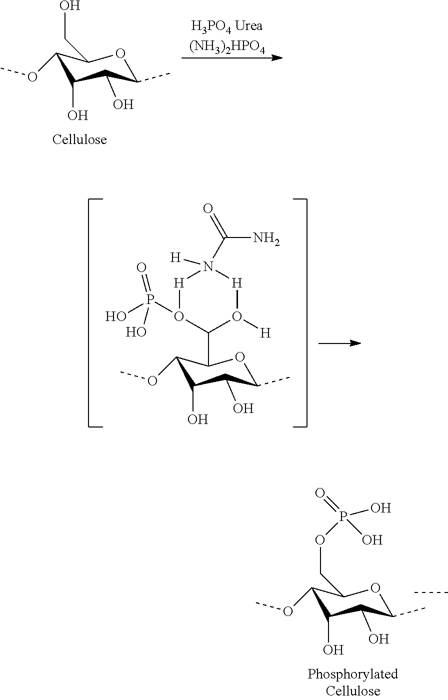

### (6) Sulfate Series Functional Groups (e.g., —SO₃—)

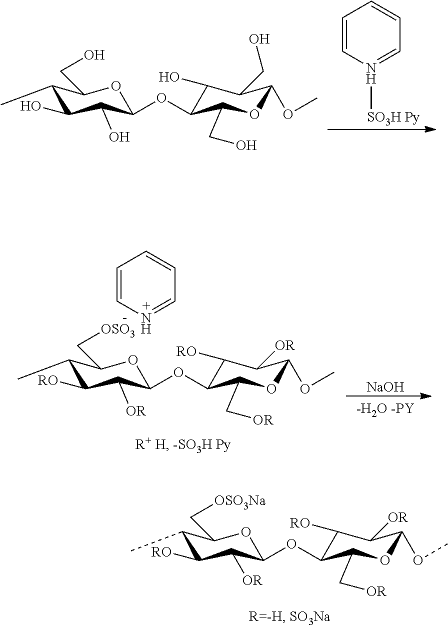

(7) Hydroxyethyl Series Functional Groups (e.g., —CH₂CH₂OH)

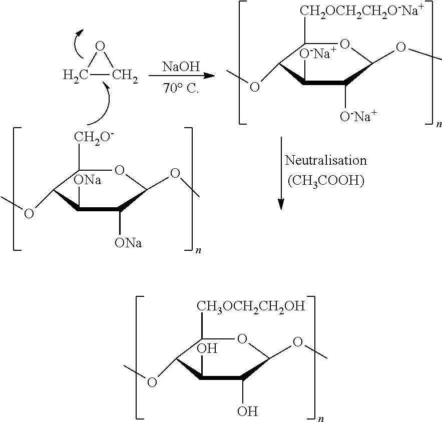

### (8) Triazine Series Functional Groups

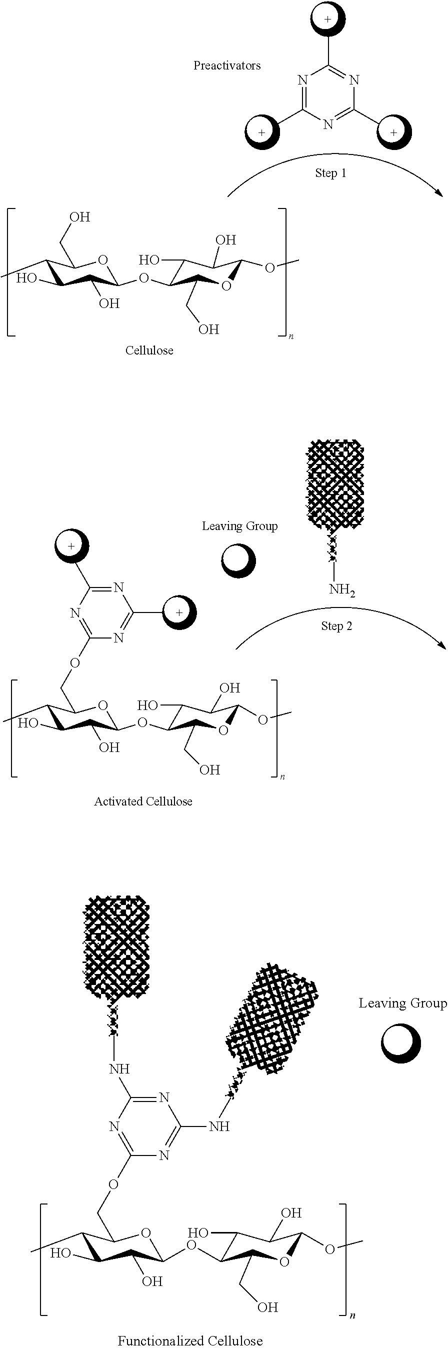

Next, the Type 2 functionalized cellulose represented by Chemical Formula 2 above is a cellulose modified such that all or part of the hydroxyl groups present in the cellulose are substituted with nitrogen, and includes, for example, a functionalized cellulose that can be manufactured by the following methods, but is not limited to the following methods or structures. 10

### (1) Imidazolium (-Im⁺) Series Functional Groups

### A: The Common Protocol for the Synthesis of Imidazolium Ionic Liquids

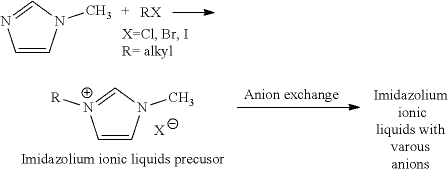

### B: The New Protocol for the Preparation of Cellulosic PILs Precursor by Chlorinated Cellulose

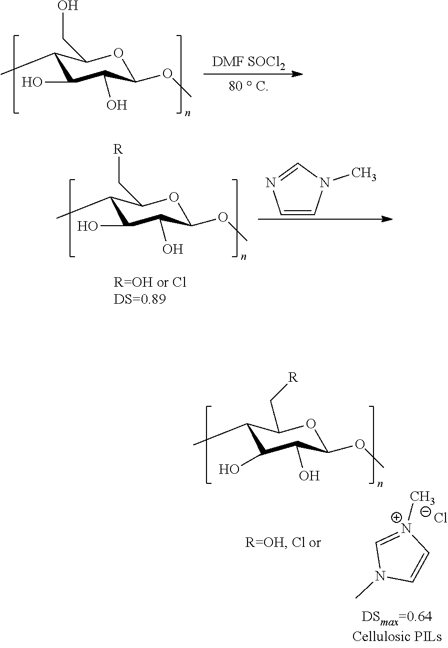

(2) Amine (—NH₂, —NHR, —NR₂, —NH₂ (CH₂)₂NH₂) Series Functional Groups

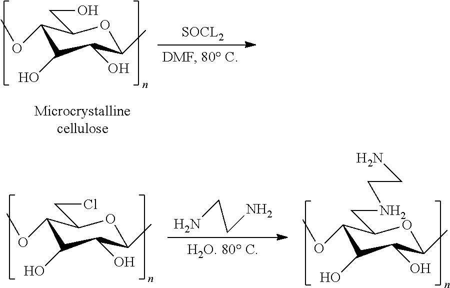

Furthermore, the Type 3 functionalized cellulose represented by Chemical Formula 3 above is a cellulose modified such that all or part of the hydroxymethyl groups present in the cellulose are transformed into carboxylate or the like, and includes, for example, a functionalized cellulose that can be manufactured by the following methods, but is not limited to the following methods or structures.

### Carboxyl Group Series Functional Groups (TEMPO-Oxidation)

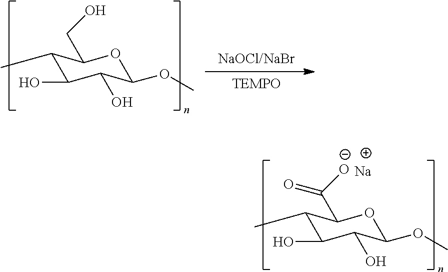

Lastly, the Type 4 functionalized cellulose represented by Chemical Formula 4 above is a cellulose modified such that all or part of the cellulose ring is ring-opened, and includes, for example, a functionalized cellulose that can be manufactured by the following methods, but is not limited to the following methods or structures.

### (1) Aldehyde Group (e.g., —CHO) Series Functional Groups

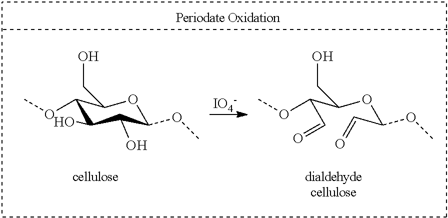

(2) Imidazolium Group (-Im⁺) Series Functional Groups

### (3) Carboxyl Group Series Functional Groups

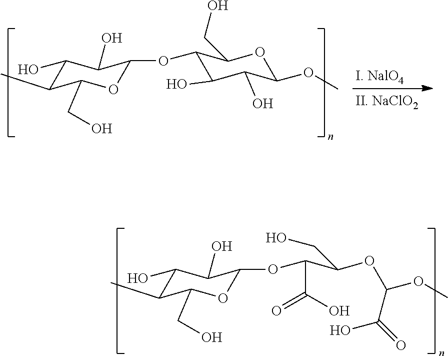

According to yet another embodiment, in Chemical Formula 1, n1 is an integer from 100 to 10,000,
R¹ to R⁶ are each independently a hydrogen atom or

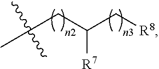

n2 and n3 are each independently 1 or 2,
R⁷ is a hydrogen atom or a hydroxyl group,
R⁸ is a cationic functional group of

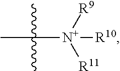

R⁹ to R¹¹ are each independently a hydrogen atom or a methyl group, the cationic functional group includes a counter anion thereto, and the counter anion is one or more selected from a halogen-based ion, a sulfone-based ion, a phosphate-based ion, a borate-based ion, a sulfite or sulfate ion, a nitrate ion, perchlorate (ClO₄_{^{−}}), hydroxamate (—C(O)NHO⁻), and a sulfate ion (SO₄²⁻).

According to yet another embodiment, the functionalized cellulose is represented by Chemical Formula 1; n1 is an integer from 100 to 10,000; specifically, R¹ to R⁶ are each independently selected from a hydrogen atom, CH(OH)—CH₂—N⁺ (CH₃)₃, CH₂—CH(OH)—CH₂—N⁺ (CH₃)₃, and C(═O)—CH₂—CH₂—CH₂—N⁺ (CH₃)₃, and at least some of R¹ to R⁶ are selected from CH(OH)—CH₂—N⁺ (CH₃)₃, CH₂—CH(OH)—CH₂—N⁺ (CH₃)₃, and C(═O)—CH₂—CH₂—CH₂—N⁺ (CH₃)₃; the cationic functional group includes a counter anion thereto; and the counter anion is selected from one or more of a halogen-based ion, a sulfone-based ion, a phosphate-based ion, a borate-based ion, a sulfite or sulfate ion, a nitrate ion, perchlorate (ClO₄_{^{−}}), hydroxamate (—C(O) NHO⁻), and a sulfate ion (SO₄²⁻).

When the wet cathode binder is specifically as described above, it is preferable in that it exhibits high compatibility with aqueous processes, allowing for excellent stability in aqueous dispersion systems and reduced conductive agent usage and the effects of high-loading electrodes without the use of harmful solvents, and enables the manufacturing of high-loading electrodes, and unlike other binders, it can exhibit a synergistic effect of simultaneously improving the mutually exclusive properties of interfacial adhesion and ion transport.

According to yet another embodiment, 60% or more of R³, preferably 70% or more, more preferably 80% or more, and 60% or more of R⁴, preferably 70% or more, more preferably 80% or more, are hydrogen atoms. In this case, the remainder of R³ and the remainder of R⁴ are each independently selected from

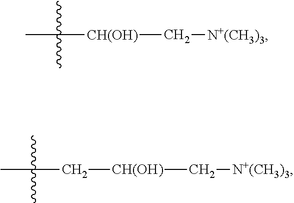

and

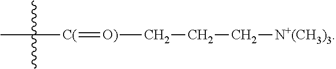

Furthermore, 60% or more of R¹, preferably 70% or more, more preferably 80% or more; 60% or more of R², preferably 70% or more, more preferably 80% or more; 60% or more of R⁵, preferably 70% or more, more preferably 80% or more; and 60% or more of R⁶ are each independently selected from

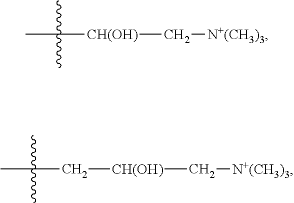

and

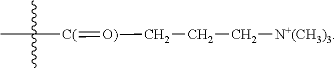

Also, in this case, the remainder of R¹, the remainder of R², the remainder of R⁵, and the remainder of R⁶ are hydrogen atoms.

When the wet cathode binder is specifically as described above, it is preferable in that, due to high surface energy and high intermolecular interaction, it can exhibit a self-healing phenomenon even if micro-cracks occur within the electrode, thereby greatly improving the long-term life and reliability of the electrode and maintaining stable performance even in high-loading and high-density electrodes.

In particular, satisfying the more preferred range (80% or more) above is even more preferable because, unlike the lower range (60% or more or 70% or more) above, the 3D thermal-conduction network formed by the cationic CNF binder promotes heat dispersion within the electrode and suppresses local overheating during high-rate charging and discharging, thereby greatly improving the thermal stability and cycle life of the battery, and further exhibits the heterogeneous effect of improving the internal penetration of the electrolyte into the electrode by adjusting the hydrophilicity/hydrophobicity balance of the electrode surface by the cationic functional group.

According to yet another embodiment, the functionalized cellulose has a degree of substitution of 0.03 to 3. In the present invention, the degree of substitution refers to the average number of substituted functional groups among the three active hydroxyl groups (—OH) present in one anhydroglucose unit (AGU) within the functionalized cellulose.

According to yet another embodiment, the cellulose is selected from one or more of cellulose nanofibers (CNF), cellulose nanocrystal (CNC), microfibrillated cellulose (MFC), microcrystalline cellulose (MCC), and bacterial cellulose.

In particular, when cationic cellulose nanofibers (CNF) having a degree of substitution of 0.3 to 4 are used as a wet cathode binder, it is more preferable in that the cationic CNF can simultaneously have high mechanical strength and flexibility, exhibiting excellent crack resistance or dimensional stability, capable of maintaining the structure long-term without any cracking or peeling even after significant expansion and contraction during charge and discharge cycles.

According to yet another embodiment, the cellulose nanofibers have a diameter of 1 nm to 100 μm and a length of 50 nm to 500 μm, and the cellulose nanocrystals have a diameter of 1 nm to 100 μm.

Another aspect of the present invention relates to a composition for a secondary battery wet cathode, including the binder for a secondary battery electrode according to various embodiments of the present invention.

Another aspect of the present invention relates to a secondary battery wet cathode including the binder for a secondary battery electrode according to various embodiments of the present invention.

In the present invention, a wet cathode means a cathode manufactured by a wet method. Whether the cathode of a lithium ion secondary battery is manufactured by a wet process or a dry process can be easily confirmed by a person skilled in the art through observing the characteristics of the manufacturing process or analyzing the manufactured cathode.

Generally, the wet process is a method of mixing an active material, a conductive agent, a binder, and a solvent (e.g., NMP, water, etc.) to create a slurry, coating it onto a current collector (Al foil, etc.), and then drying it. The dry process is a method of mixing the binder, active material, and conductive agent without a solvent, and then directly pressing and attaching it to the current collector using rolling or the like. Therefore, in the wet process, slurry mixing equipment, coating machines, and dryers are used, and in the dry process, rolling mills and presses are mainly used, and they can be easily distinguished by observing the characteristics of the manufacturing process.

However, even without observing the manufacturing process, a person skilled in the art can easily confirm whether it is a wet process through analysis of whether the solvent used in the wet process remains. That is, it can be easily confirmed by observing the microstructure, surface, and thickness uniformity of the manufactured cathode sheet. Generally, a cathode sheet manufactured by the wet process shows an even distribution of active material particles and binder, and smooth surface and uniform coating are observed, whereas a cathode sheet manufactured by the dry process has weak bonding between particles, and the surface may be rough or non-uniform. Furthermore, a cathode manufactured by the wet process has a consistent coating thickness, and uniformity can be confirmed by beta-ray measurement, while the uniformity may be poor in the dry process. Also, when observing the surface and cross-section using a scanning electron microscope (SEM) or the like, the wet process shows a uniform particle distribution, while the dry process shows less strong bonding between particles.

Another aspect of the present invention relates to a secondary battery including the wet cathode according to various embodiments of the present invention.

Another aspect of the present invention relates to a device selected from one of portable electronic devices, mobile units, power devices, and energy storage systems, including the secondary battery according to various embodiments of the present invention.

Hereinafter, the present invention will be described in more detail through examples and the like, but the scope and content of the present invention cannot be narrowed or limited by the examples and the like below. Furthermore, based on the disclosure of the present invention including the examples below, it is obvious that those skilled in the art can easily carry out the present invention even if specific experimental results are not presented, and it is natural that such variations and modifications fall within the scope of the appended claims.

In addition, the experimental results presented below only describe representative experimental results of the said examples and comparative examples, and the respective effects of various embodiments of the present invention not explicitly presented below will be specifically described in the relevant sections.

### EXAMPLES

### Manufacturing Example 1: Preparation of Cationic Cellulose Nanofibers (c-CNF)

According to a method known in Adv. Funct. Mater. 2019. 29, 1902772, etc., a 7 wt % NaOH aqueous solution, a 12 wt % urea aqueous solution, and a 3 wt % CNF suspension were prepared separately and mixed. CHPTAC (3-chloro-2-hydroxypropyltrimethylammonium chloride), a cationic monomer, was added to this mixture such that the molar ratio of CNF:cationic monomer was 1:15, and the mixture was stirred at 500 rpm at 70° C. Impurities were removed by washing in running water using dialysis tubing. LiTFSI salt was added in the same weight as CNF and stirred at 500 rpm at 50° C., and then impurities were removed by washing in running water.

### Example 1: Preparation of Wet Cathode

A cathode slurry was prepared by dissolving and mixing a cathode active material (LiNi0.8Mn0.1Co0.1O2, NCM811), a conductive agent (Super P), and a binder (c-CNF of Manufacturing Example 1) in a weight ratio of 96:2:2 in a solvent (water or ethylene glycol). This was coated onto an Al current collector in a titanium mold and then vacuum-dried at 120° C. to prepare a wet cathode.

### Comparative Example 1: Preparation of Wet Cathode

A cathode was manufactured by the same wet method as Example 1, except that a commercial PVdF binder was used instead of the c-CNF binder of Manufacturing Example 1.

### Device Example 1: Preparation of Coin Half-Cell

A 2032-type coin cell (cathode|PE separator|anode) containing liquid electrolyte was fabricated for electrochemical performance evaluation, using the cathode of Example 1, a PE separator (20 μm, Toray-Tonen), and an anode (lithium metal 200 μm). The liquid electrolyte used was IM LiPF6 in EC/EMC (3/7, w/w)+10 wt % FEC+2 wt % VC. The cell was assembled in an argon-filled glove box.

### Device Comparative Example 1: Preparation of Coin Half-Cell

A battery was fabricated by the same method as Device Example 1, except that the cathode of Comparative Example 1 was used instead of the cathode of Example 1.

### Test Example 1: FT-IR Analysis

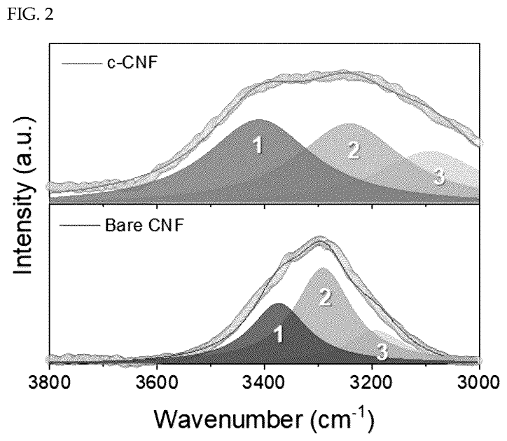

FT-IR was analyzed for both untreated CNF and c-CNF of Manufacturing Example 1, and the results are presented in FIG. 2. Cationic CNF, which shows lower internal interaction compared to CNF, suggests the possibility of having higher interaction with the active material, conductive agent, and current collector.

### Test Example 2: TEM Analysis

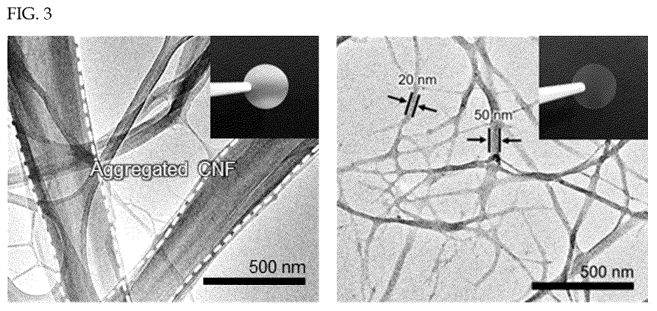

TEM images were taken for both untreated CNF and c-CNF of Manufacturing Example 1, and the images are presented in FIG. 3. While CNF, which has relatively strong internal interaction, shows a phenomenon where some CNFs aggregate (left), cationic CNF, which has relatively low internal interaction, can be confirmed to have a thin and non-aggregated form (right).

### Test Example 3: Contact Angle Measurement and Raman Analysis

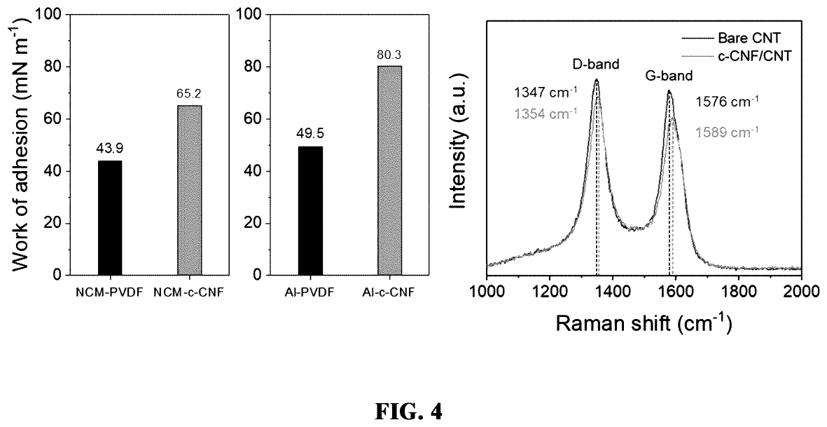

The contact angle was measured for each of the conventional PVdF binder and the c-CNF of Manufacturing Example 1 to obtain the contact angle-based work of adhesion, and Raman analysis was performed on each of them, and presented the results to FIG. 4.

In the left graph of FIG. 4, the affinity quantification result between the binder (PVdF or c-CNF) and the active material (NCM) derived from the contact angle-based work of adhesion analysis is shown, the middle graph is the affinity quantification result between the binder and the current collector (Al) derived by the same method, and the right graph shows the change in affinity with the conductive agent following the introduction of cationic CNF into CNF. This shows that cationic CNF has superior affinity with the active material, current collector, and conductive agent compared to PVdF.

### Test Example 4: Elasticity and Viscosity Measurement

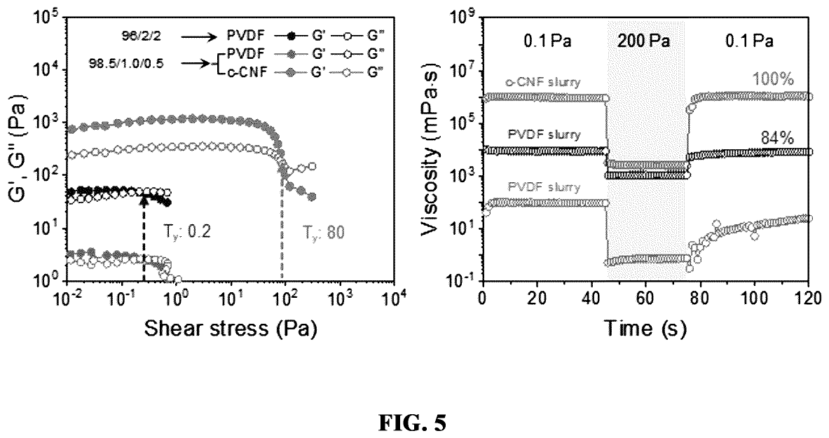

Elasticity and viscosity were measured for each of the conventional PVdF binder and the c-CNF of Manufacturing Example 1, and the results are presented in FIG. 5. Compared to PVdF, cationic CNF is confirmed to have high elasticity (G′, G″ intersection point) and viscosity, indicating that it will have relatively greater resistance to stress generated during the solvent drying process and a non-uniformity alleviation effect.

### Test Example 5: Interfacial Resistance Measurement

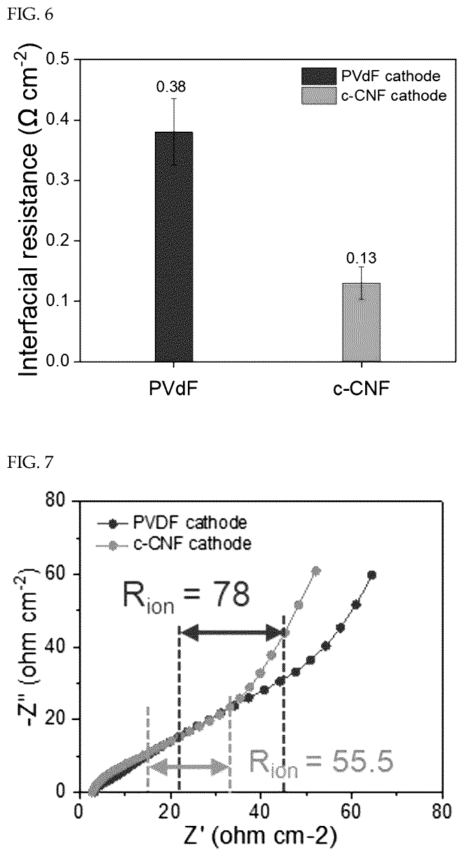

Interfacial resistance was measured for each of the cathode of Example 1 (c-CNF) and the cathode of Comparative Example 1 (PVdF), and the results are presented in FIG. 6. Compared to PVdF, it is shown that cationic CNF lowered the interfacial resistance further by improving physical contact through relatively higher adhesion.

### Test Example 6: Ion Conductivity Resistance Value Measurement

The ion conductivity resistance value within the electrode was measured for each of the cathode of Example 1 (c-CNF) and the cathode of Comparative Example 1 (PVdF), and the results are presented in FIG. 7. Compared to PVdF, it shows that cationic CNF has relatively lower ion conductivity resistance within the electrode, which is because cationic CNF has a fibrous structure, unlike PVdF.

### Test Example 7: Rate Capability and Cycle Life Performance Analysis

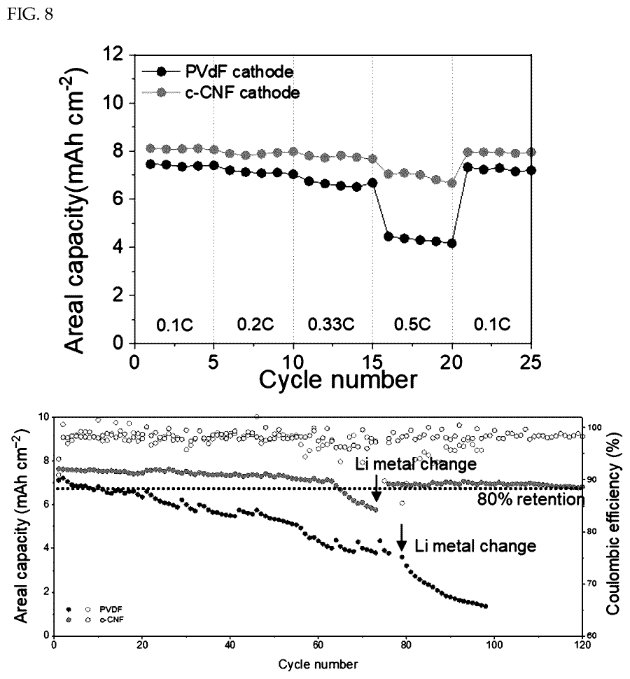

The rate capability and cycle life performance were analyzed for each of the battery of Device Example 1 (c-CNF) and the battery of Device Comparative Example 1 (PVdF), and the results are presented in FIG. 8. The results show the charging and discharging progress of a half-cell fabricated using a 20 μm thick separator placed between 200 μm Li metal and each electrode, using 1 M LiPF6 EC/EMC (3/7 v/v)+10 wt % FEC+2 wt % VC electrolyte. The capacity retention rate according to various current densities and the charge/discharge cycle characteristics were compared using the half-cell. It is shown that the rate capability and cycle life characteristics of the cationic CNF-based battery are superior to those of the PVdF-based battery.

### Test Example 8: Electrochemical Property Analysis

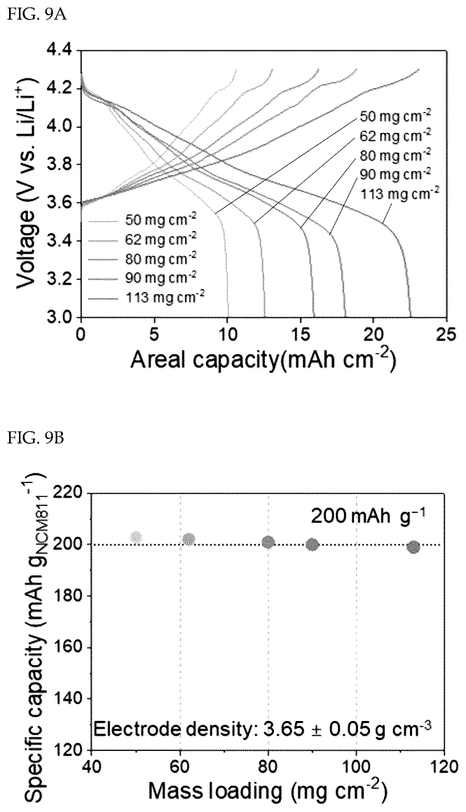

Electrochemical properties were analyzed for each of the battery of Device Example 1 (c-CNF) and the battery of Device Comparative Example 1 (PVdF), and the results are presented in FIGS. 9A to 9B. FIGS. 9A to 9B show that high-loading and high-density cathodes can be realized based on cationic CNF. It was confirmed that capacity could be realized based on cationic CNF even in thick electrodes and high density, which cannot be achieved based on PVdF. Furthermore, it was confirmed that all theoretical capacity that the active material should exhibit was exhibited even as the loading increased. This result is attributed to the excellent dispersion ability and adhesion of cationic CNF.

Specific parts of the present invention have been described in detail above, and it is obvious that this detailed description is merely preferred embodiments to those skilled in the art. The scope of the present invention is not limited only to the experimental results presented in the examples and comparative examples, and is defined by the appended claims and their equivalents.

What is claimed is:

1. A binder for a secondary battery electrode comprising functionalized cellulose, wherein the functionalized cellulose is one or more selected from a modified cellulose such that a cationic functional group is bonded thereto and a modified cellulose such that a polar functional group is bonded thereto.

2. The binder for a secondary battery electrode of claim 1, wherein the secondary battery electrode is a secondary battery wet cathode.

3. The binder for a secondary battery electrode of claim 1,
wherein the cationic functional group is one or more functional groups selected from ammonium (—NH₄⁺), primary to quaternary ammonium (—NH₃R⁺, —NH₂R₂⁺, —NHR₃⁺, —NR₄⁺), pyridinium (-Py⁺), imidazolium (-Im⁺), triazolium (-Trz⁺), thiazolium (-Thz⁺), phosphonium (e.g., —PR₄⁺), sulfonium (e.g., —SR₃⁺), hydrazonium (—N₂H₅⁺), and peroxyammonium (—N(O₂) R₃⁺), and
the polar functional group is one or more selected from a carboxyl group (—COOH), a cyano group (—C═N), an amino group (—NH₂), a secondary or tertiary amine group (—NHR, —NR₂), a thiol group (—SH), —O—(C═O) OH, O═C—NH₂, an ether group (—O—), an ester group (—C(O)O—), an amide group (—C(O) NH—), a carbonate group (—OC(O)O—), a urea group (—NHC(O) NH), a urethane group (—OC(O) NH—) and an imide group (—C(O) NH—C(O)—).

4. The binder for a secondary battery electrode of claim 3,
wherein the functionalized cellulose is represented by the following Chemical Formula 1, 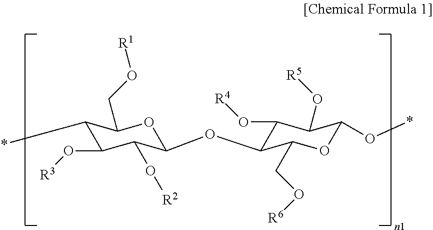
the n1 is an integer from 100 to 10,000,
the R¹ to the R⁶ are each independently selected from a hydrogen atom, 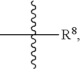
and 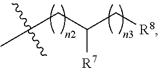
at least some of the R¹ to the R⁶ are each independently 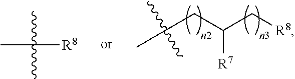
the n2 and the n3 are each independently an integer from 1 to 4,
the R⁷ is selected from a hydrogen atom, a hydroxyl group, and a C₁-C₄ alkyl group,
the 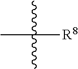
is selected from 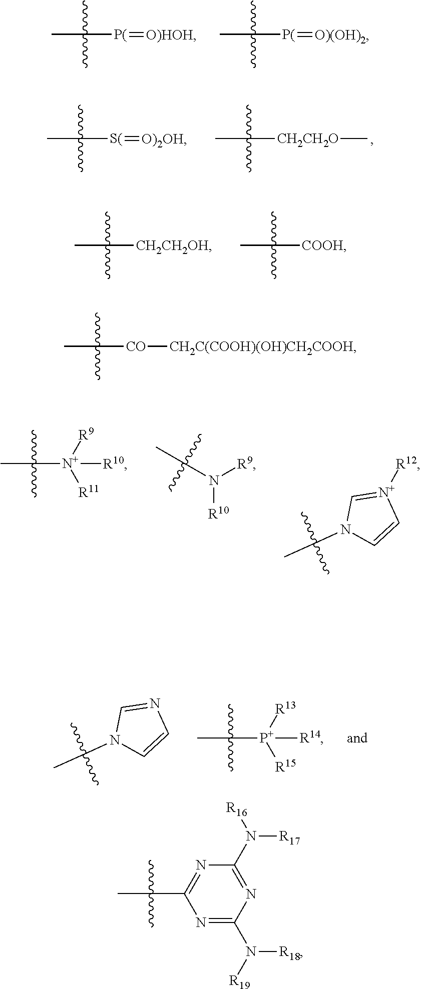
R⁹ to R¹⁹ are each independently a hydrogen atom or a C₁-C₄ alkyl group.

5. The binder for a secondary battery electrode of claim 3,
wherein the functionalized cellulose is represented by the following Chemical Formula 2, 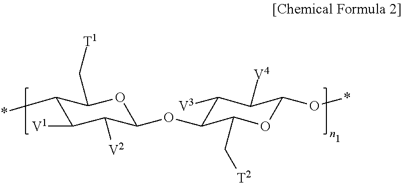
the n1 is an integer from 100 to 10,000,
the 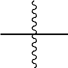
and the 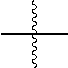
are each independently selected from a hydroxyl group, 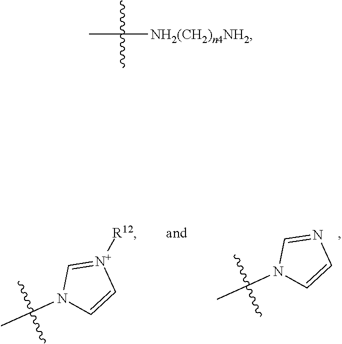
the n4 is an integer from 1 to 5,
the R¹² is a hydrogen atom or a C₁-C₄ alkyl group, and
the V¹ to V⁴ are each independently a hydroxyl group or a C₁-C₄ alkoxy group.

6. The binder for a secondary battery electrode of claim 3,
wherein the functionalized cellulose is represented by the following Chemical Formula 3, 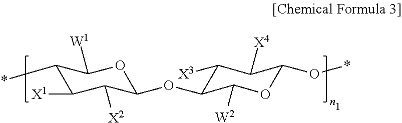
the n1 is an integer from 100 to 10,000,
the 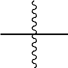
and the 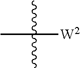
are each independently selected from a hydroxymethyl group, 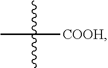 [SMILES: *C(=O)O]
and 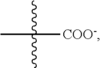
and
the X¹ to the X⁴ are each independently a hydroxyl group or a C₁-C₄ alkoxy group.

7. The binder for a secondary battery electrode of claim 3,
wherein the functionalized cellulose is represented by the following Chemical Formula 4, 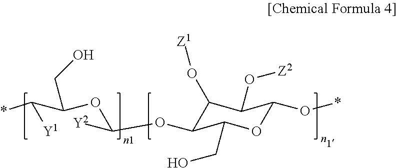
the n1 and n1′ are each independently an integer from 100 to 10,000,
the 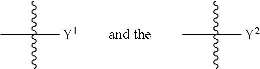
are each independently selected from 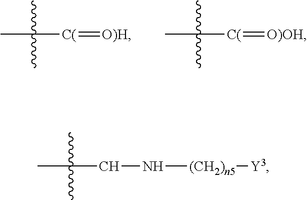
and 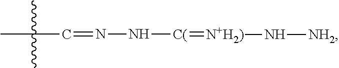
or
the 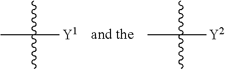
are connected to each other to form 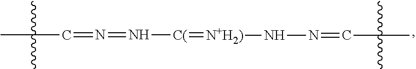
the 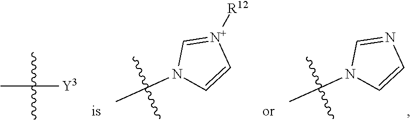
and
the R¹² is a hydrogen atom or a C₁-C₄ alkyl group.

8. The binder for a secondary battery electrode of claim 3,
wherein the functionalized cellulose is one or more selected from

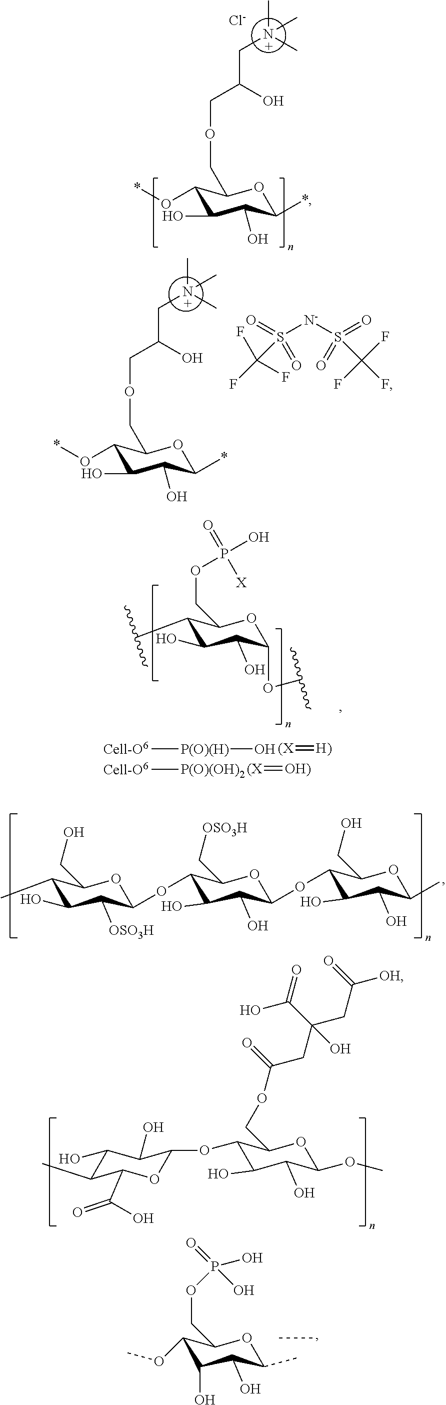

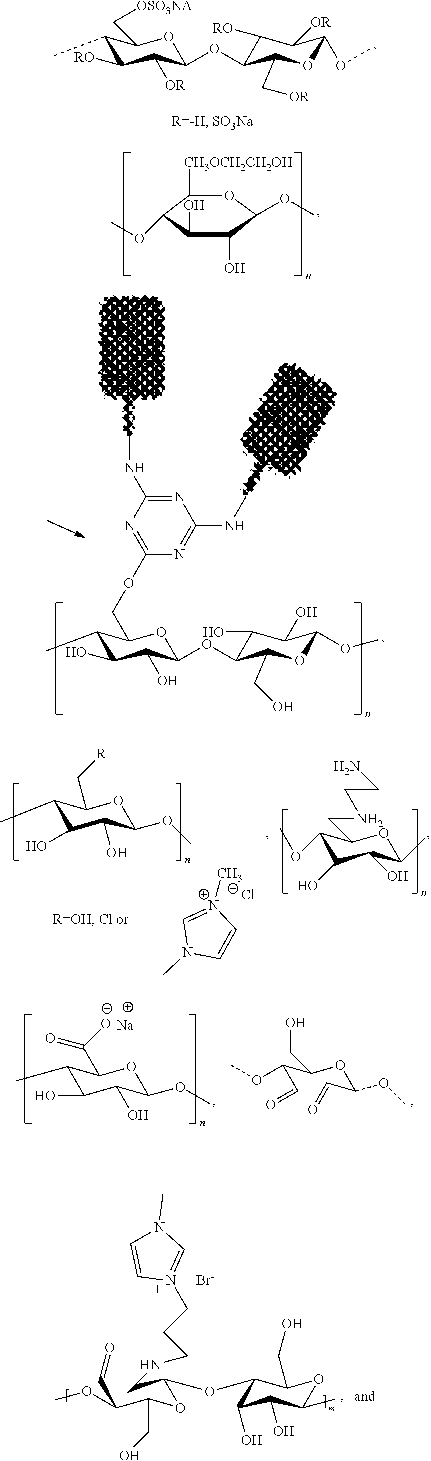

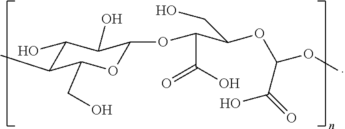

9. The binder for a secondary battery electrode of claim 3,
wherein the functionalized cellulose is represented by the Chemical Formula 1, the n1 is an integer from 100 to 10,000,
the R¹ to the R⁶ are each independently a hydrogen atom or 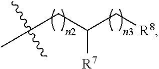
the n2 and the n3 are each independently 1 or 2,
the R⁷ is a hydrogen atom or a hydroxyl group,
the R⁸ is 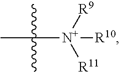
the R⁹ to the R¹¹ are each independently a hydrogen atom or a methyl group,
the cationic functional group includes a counter anion thereto, and
the counter anion is one or more selected from a halogen-based ion, a sulfone-based ion, a phosphate-based ion, a borate-based ion, a sulfite or sulfate ion, a nitrate ion, perchlorate (ClO₄₋), hydroxamate (—C(O)NHO⁻), and a sulfate ion (SO₄²⁻).

10. The binder for a secondary battery electrode of claim 3,
wherein the functionalized cellulose is represented by the Chemical Formula 1, 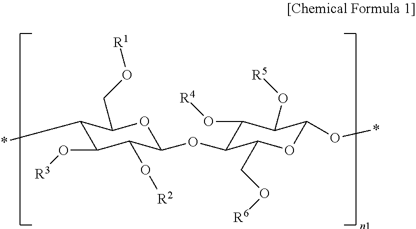
the n1 is an integer from 100 to 10,000,
the R¹ to the R⁶ are each independently selected from a hydrogen atom, CH(OH)—CH₂—N⁺(CH₃)₃, CH₂—CH(OH)—CH₂—N⁺(CH₃)₃, and C(═O)—CH₂—CH₂—CH₂—N⁺(CH₃)₃, at least some of the R¹ to the Re are selected from CH(OH)—CH₂—N⁺ (CH₃)₃, CH₂—CH(OH)—CH₂—N⁺ (CH₃)₃, and C(═O)—CH₂—CH₂—CH₂—N⁺ (CH₃)₃,
the cationic functional group includes a counter anion thereto; and
the counter anion is one or more selected from a halogen-based ion, a sulfone-based ion, a phosphate-based ion, a borate-based ion, a sulfite or sulfate ion, a nitrate ion, perchlorate (ClO₄₋), hydroxamate (—C(O)NHO⁻), and a sulfate ion (SO₄²⁻).

11. The binder for a secondary battery electrode of claim 10,
wherein 60% or more of the R³ and 60% or more of the R⁴ are hydrogen atoms,
the remainder of the R³ and the remainder of the R⁴ are each independently selected from 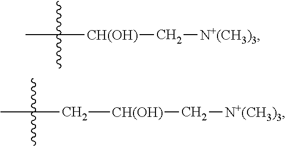
and 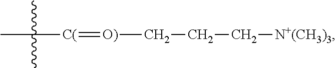
60% or more of the R¹, 60% or more of the R², 60% or more of the R⁵, and 60% or more of the R⁶ are each independently selected from 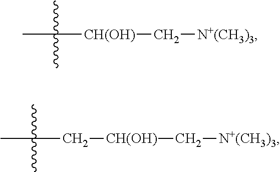
and 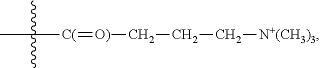
and
the remainder of the R¹, the remainder of the R², the remainder of the R⁵, and the remainder of the R⁶ are hydrogen atoms.

12. The binder for a secondary battery electrode of claim 3,
wherein the functionalized cellulose has a degree of substitution of 0.03 to 3, and
the degree of substitution is the average number of substituted functional groups among the three active hydroxyl groups (—OH) present in one anhydroglucose unit (AGU) within the functionalized cellulose.

13. The binder for a secondary battery electrode of claim 3,
wherein the cellulose is one or more selected from cellulose nanofibers (CNF), cellulose nanocrystal (CNC), microfibrillated cellulose (MFC), microcrystalline cellulose (MCC), and bacterial cellulose.

14. The binder for a secondary battery electrode of claim 13,
wherein the cellulose nanofibers have a diameter of 1 nm to 100 μm and a length of 50 nm to 500 μm, and the cellulose nanocrystals have a diameter of 1 nm to 100 μm.

15. A composition for a secondary battery wet cathode comprising the binder for a secondary battery electrode according to claim 10.

16. A secondary battery wet cathode comprising the binder for a secondary battery electrode according to claim 10.

17. A secondary battery wet cathode comprising the binder for a secondary battery electrode according to claim 11.

18. A secondary battery comprising the wet cathode according to claim 16.

19. A secondary battery comprising the wet cathode according to claim 17.

20. A device selected from one of a portable electronic device, a mobile unit, a power device, and an energy storage system, comprising the secondary battery of claim 18.

21. A device selected from one of a portable electronic device, a mobile unit, a power device, and an energy storage system, comprising the secondary battery of claim 19.
